(19) United States
(12) Patent Application Publication
(10) Pub. No.: US 2022/0363980 A1
(43) Pub. Date: Nov. 17, 2022

(54) METHODS AND SYSTEMS ASSOCIATED WITH LUBRICANT FOR OIL SLURRY

(71) Applicant: HIGHLAND FLUID TECHNOLOGY, Houston, TX (US)

(72) Inventors: Shawn Lu, Katy, TX (US); Kevin Wilbur Smith, Bellaire, TX (US)

(21) Appl. No.: 17/745,175

(22) Filed: May 16, 2022

Related U.S. Application Data
(60) Provisional application No. 63/189,379, filed on May 17, 2021.

(51) Int. Cl. C09K 8/64; C09K 8/70; C09K 8/60

(52) U.S. Cl. CPC C09K 8/64; C09K 8/70; C09K 8/604; C09K 2211/00; C09K 2208/28

(57) ABSTRACT

A slurry comprised of paraffinic or aromatic hydrocarbons, a viscosifier, a dry friction reducer polymer, and a lubricant.

### BACKGROUND INFORMATION

### Field of the Disclosure

Examples of the present disclosure relate to systems and methods associated with lubricants for slurries. More specifically, embodiments are directed towards slurry comprised of paraffinic or aromatic hydrocarbons, a viscosifier, a dry friction reducer polymer, and a lubricant, wherein the lubricant is configured to reduce heat and viscosity of suspended solids within the slurry.

### Background

Fracturing is a process where fluids are pumped into a hydrocarbon reservoir to create a crack or fracture in the hydrocarbon bearing rock. The jobs are pumped at high-rate and high-pressure and rate is limited by the maximum wellhead treating pressure and the burst pressure of the tubulars used. Friction reducers are typically polyacrylamide-based polymers that lower pipe-friction by forcing turbulent flow to appear more like laminar flow. The polyacrylamide polymers can be powders, liquid emulsions or concentrated slurries in oil.

Drilling is a common operation in many industries from oil and gas. During the drilling, drilling fluids are often circulated in the wellbore to achieve various functions from transporting cuttings, maintaining formation pressures and cooling down the drill-bit. Friction control is a key parameter while drilling, and friction often limits the rate of penetration by causing a buildup of solids within the slurry and increasing the temperature of the slurry. Various chemistries have been added in drilling fluids to reduce the friction between metal to metal and metal to formations.

The performance of friction reducers is a key factor for the success of fracturing operation. Conventional friction reducers, generally include dry powder, polymer emulsion, and polymer slurry suspended in a base fluid. Polymer slurry suspension provides flexibility on product formulation and eliminates the difficulties of handling of dry production during hydraulic fracturing.

Conventional friction reducers for slurries include hydrocarbons, viscosifier, dry friction reducer polymers, and surfactants. The base oil acts as the liquid phase to suspend dry polymer particles. The viscosifier or suspension agent is needed to increase the base oil viscosity to prevent the settling of polymer particles. The surfactants are used to physically separate the suspended dry polymer particles from the base oils. Yet, the surfactants do not decrease the friction between the dry polymer particles in the slurry.

However, the large amount of polymer particles creates a formulation challenge to keep the slurry viscosity in a suitable range as it affects the slurry stability and pumpability in the field. The wettability or dispersion of the polymer particles are particularly important, which is achieved by selection of the right surfactant. However, surfactants do not lower the viscosity, nor reduce the friction of the solids within the slurry.

Accordingly, needs exist for systems and methods associated with adding lubricants to a slurry to improve the pumpability of the fluid, which may decrease the friction of the solid particles within the slurry and decrease the viscosity of the fluid

### SUMMARY

Embodiments are directed towards a slurry that utilizes a GTL (gas to liquid) synthetic base oil, viscosifier, lubricants, and dry powder friction reducer.

The synthetic base oil may be used for superior environmental profile and field performance. The synthetic base oil can be made of a range of anionic and cationic polyacrylamide.

The slurry may include an organoclay or synthetic viscosifier that can be used to increase the base oil viscosity, and thus suspend a dry polymer particles in the slurry.

Lubricants, such as organic acid, acid, of alky fatty acids ranging from 3 to 20 carbon atoms, oxidized tall oil, polyamide, imidazonline or amidoamine or a mixture of the two, may reduce friction among the particles in the slurry.

Reducing the friction in the slurry may reduce pump heat, help maintain optimal slurry properties, and aide the pumpability of the slurry in the field when slurries have an elevated viscosity. Furthermore, the lubricant additives may provide a better dispersion of the dry polymer particles within the slurry.

In embodiments, the lubricant may be any additive that reduces friction between two elements, whereas a surfactant may be an additive that reduces the tension between oil and water.

In embodiments, the addition of additional lubricant within the slurry may reduce abrasion of the slurry against metal elements and other solids. This may mitigate heat buildup and allow more efficient pumping. For example, a 1% increase in lubricant additive may reduce the viscosity and temperature of the slurry. In embodiments, if the lubricant is 20% of the slurry, the pump may work more efficiently, have a coefficient of friction of 0.078 and reduce friction up to 75% when compared to fresh water. However, in embodiments of the slurry may not be made more than 50% lubricant.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a system of a flow loop for testing a friction reducer for slurry in oil and gas operations, according to an embodiment.

FIG. 2 depicts a table illustrating the results of utilizing a flow loop for testing a friction reducer for slurry in oil and gas operations, according to an embodiment.

FIG. 3 depicts a table illustrating the results of utilizing a flow loop for testing a friction reducer for slurry in oil and gas operations, according to an embodiment.

FIG. 4 depicts a graph illustrating the friction reduction % (Y-axis) vs. time (X-axis) of first slurry and second slurry, according to an embodiment.

FIG. 5 depicts a table and corresponding graph illustrating viscosity reduction of four different slurries, according to an embodiment.

FIG. 6 depicts a graph showing the results of weight loss (y-axis) for a first slurry with 1% of lubricant additive and a second slurry with 20% lubricant additive, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art, that the specific detail need not be employed to practice the present embodiments. In other instances, well-known materials or methods have not been described in detail in order to avoid obscuring the present embodiments.

Embodiments may be directed towards a composition of friction reducer suspension for a slurry in oil and gas operations, wherein the slurry may be used as a friction reducer when fracturing wellbores and as a flocculant in water treatment. The slurry may include paraffinic or aromatic hydrocarbons, such as diesel, mineral oils, etc., a viscosifier, such as organophilic clay or polymeric, a dry friction reducer polymer, such as anionic or cationic polyacrylamide, and a lubricant, such as an organic acid or acid or alky fatty acids containing from 3 to 20 carbon atoms, oxidized tall oil, polyamide, imidazole or amidoamine or a mixture of two or more. In embodiments, the slurry may include 1-20% lubricant, which may be sufficient to achieve substantial reducing in heat and allowing for sufficient dry friction reducer polymer within the slurry.

Embodiments may utilize a lubricant to have a good level of viscosity within the slurry that allows the solid particles to be suspended without being too viscous, which would limit the availability to pump the slurry. In embodiments, the slurry may include a lubricant formed of an organic fatty acid, which is not conventionally used within slurries. Conventionally, slurry formulations focus on the stability and the common use is a surfactant/wetting agent to make the polymer particles oil wet, wherein when wetting the suspended polymers attempt to physically separate the suspended particles from the hydrocarbons and downhole surfaces. However, the lubricant additive performs similarly by allowing the suspended particles to move away from each other within the slurry by reducing the friction between the solid particles and surfaces.

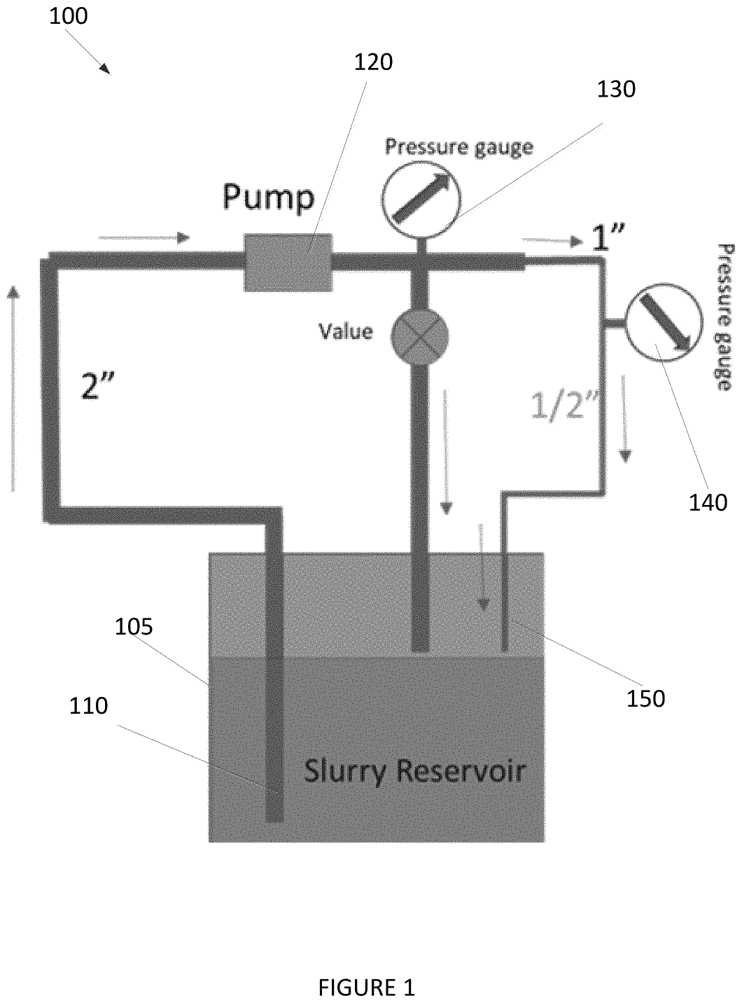

FIG. 1 depicts a system 100 of a flow loop for testing a friction reducer for slurry in oil and gas operations, according to an embodiment. System 100 may be configured to test downhole conditions associated with pumping slurry downhole. System 100 may include a reservoir 105, an inlet pipe 110, pump 120, first pressure gauge 130, second pressure gauge 140, and outlet pipe 150

Reservoir 105 may be a chamber, container, basin, etc. that is configured to hold and store slurry. In embodiments, the slurry may refer to any liquid with suspended solids. For example, the slurry may include Paraffinic or aromatic hydrocarbons, a viscosifier, a dry friction reducer polymer, and lubricants.

### Examples of Slurry Formulations

| | | 3 ppg | | Product |
|---|---|---|---|---|
| Component | Description | slurry | | Example |
| Oil phase | Paraffinic or aromatic | 58.2% | wt | Neoflo |
| | hydrocarbon | | | 4633 from |
| | | | | Shell |
| Viscosifier | Synthetic polymeric | 1.8% | wt | Kraton MD |
| | viscosifier, Poly styrene- | | | 8702 |
| | ethylene/propylene-styrene | | | |
| Dry polymer | Dry polyacrylamide friction | 39% | wt | DrySlik |
| | reducer or other dry | | | 520, |
| | polymers | | | Highland |
| | | | | Fluid |
| | | | | Technology |
| Lubricant | TOFA based polyamide | 1% | wt | |
| additive | | | | |

The paraffinic or aromatic hydrocarbons may be base oils for a superior environmental profile and field performance.

The viscosifier may be include organophilic clay, polystyrene block polymer or rheology modifiers of a mixture. The rheological modifier is dimer trimer fatty acid or dimer fatty acid reacted with amine. The viscosifier may be configured to increase the base oil viscosity, and thus suspends the dry polymer particles.

The dry friction reducer may be anionic or cationic polyacrylamide, which may be configured to reduce the pumping pressure. This may enable operators to pump more water and deliver more sand or proppant to the fractures.

The lubricant may be an organic acid or acid or alky fatty acids containing from 3 to 20 carbon atoms, oxidized tall oil, polyamide, imidazole or amidoamine or a mixture of two or more. Examples of the acid group include stearic, oleic, caproic and butyric acid. The lubricant may also include dimer and trimer fatty acids. Fatty acid calcium salt can be used as well. In addition to oxidized tall oil, polyaminated fatty acids, and partial amides of fatty acids are also suitable for use as lubricants. In other embodiments, the lubricant may be oleophilic amine compounds that are amino amides derived from preferably long-chain carboxylic acids and poly functional, particularly lower, amines of the above-mentioned type.

When testing the efficiencies of different types of slurries, reservoir 105 may hold and store the different types of slurries. In embodiments, reservoir 105 may also have a thermometer that is configured to measure a temperature of the slurry positioned within reservoir 105.

Inlet pipe 110 may be a line configured to move the slurry from reservoir 105 via pump 120. The inlet pipe may have a first diameter, such as two inches.

Pump 120 may be a device that moves the slurry from reservoir 105 through inlet pipe 110.

First pressure gauge 130 may be configured to measure a pressure of the slurry flowing through a pipe having the first diameter. Second pressure gauge 140 may be configured to measure a pressure of the slurry flowing through a pipe having a second diameter, wherein the second diameter is smaller than the first diameter. Utilizing the difference in the pressure measurements and the temperature of the slurry, the relative viscosity of the slurry may be determined. This is due to pressure differentials being related to the relative viscosity of the slurries.

Outlet pipe 150 may be configured to emit the slurry back into reservoir 105 after the first pressure gauge 130 and the second pressure gauge 140 have measured their respective pressures.

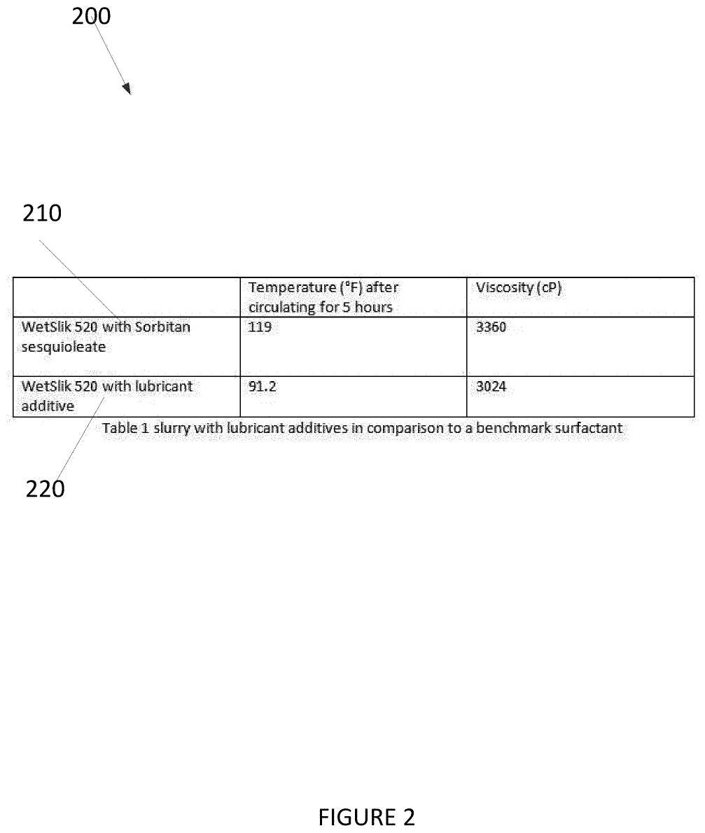

FIG. 2 depicts a table 200 illustrating the results of utilizing system 100 for testing a friction reducer for slurry in oil and gas operations, according to an embodiment.

The results in table 200 may correspond with a first type of slurry 210 being stored in a reservoir 105 for testing, followed by a second type of slurry 220 being stored in a reservoir 105 for testing. The first type of slurry 210 may be conventional slurry that utilizes a surfactant. The second type of slurry 220 may include a lubricant, such as an organic acid or acid or alky fatty acids containing from 3 to 20 carbon atoms, wherein slurry 220 may not include a surfactant or may less than 3% surfactant.

After circulating the slurries 210, 220 for five hours within testing loop 100, first slurry 220 had a temperature of 110 degrees Fahrenheit and a viscosity (cP) of 3360. After the same period of time, second slurry 220 had a temperature of 91.2 degrees Fahrenheit and a viscosity (cP) of 3024. Accordingly, the second slurry 220 has a lower temperature, lower pressure drop, and lower viscosity, which can all pump 120 to operate more efficiently for a longer period of time due to reducing the friction of the slurry 220 through the elements. For example, after circulating first slurry 210 through testing loop 100 for 90 minutes, pump 120 stalled. On the other hand, circulating second slurry 220 through testing loop for 300 minutes did not cause pump failure.

In embodiments, it may be desirable to reduce friction and temperatures because the higher temperatures and friction causes pumps to heat up, and heat destabilizes the suspension of solids within the slurry. More specifically, a Dry Friction Reducer Polymer within slurry may agglomerate on surfaces at temperatures above 120 to 150 F. If the polymer is agglomerated and packed tightly when flowing into a pump, the polymer may build up in the flow lines, restrict flow through the lines. This requires the lines and pumps to be conditionally flushed with solvents to remove the buildup. Accordingly, second slurry 220 with the lubricant can mitigate heat buildup, and prevent of limit the polymer solids from depositing on surfaces.

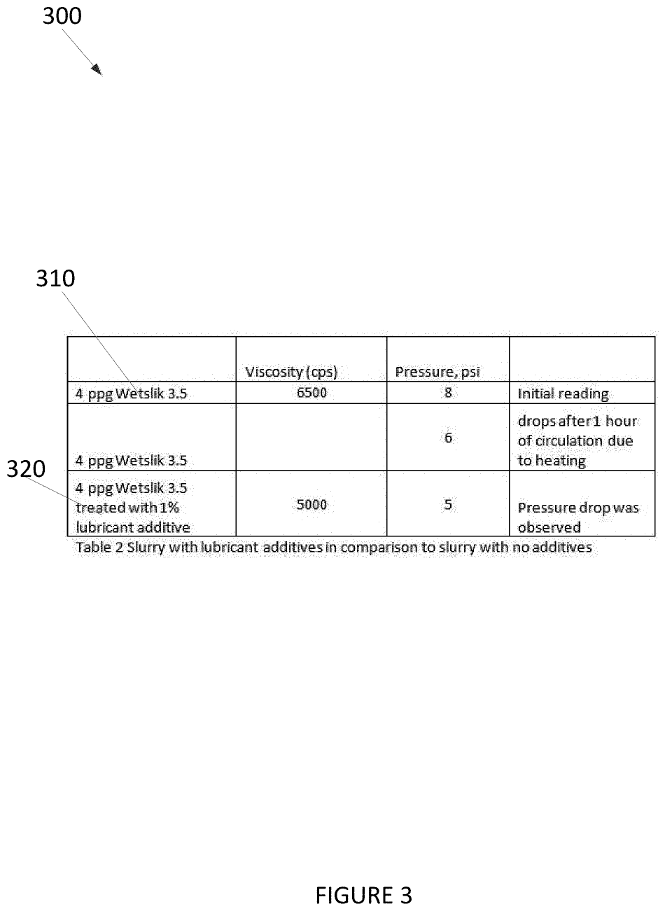

FIG. 3 depicts a table 300 illustrating the results of utilizing system 100 for testing a friction reducer for slurry in oil and gas operations, according to an embodiment. Specifically, table 300 depicts a viscosity drop and pressure drop by using a lubricant additive within second slurry 320 compared to first slurry 310 without a lubricant. Specifically, the larger drop in pressure for slurry 320 with the lubricant may be beneficial in field operations when the slurry is pumped with a lower volume rate.

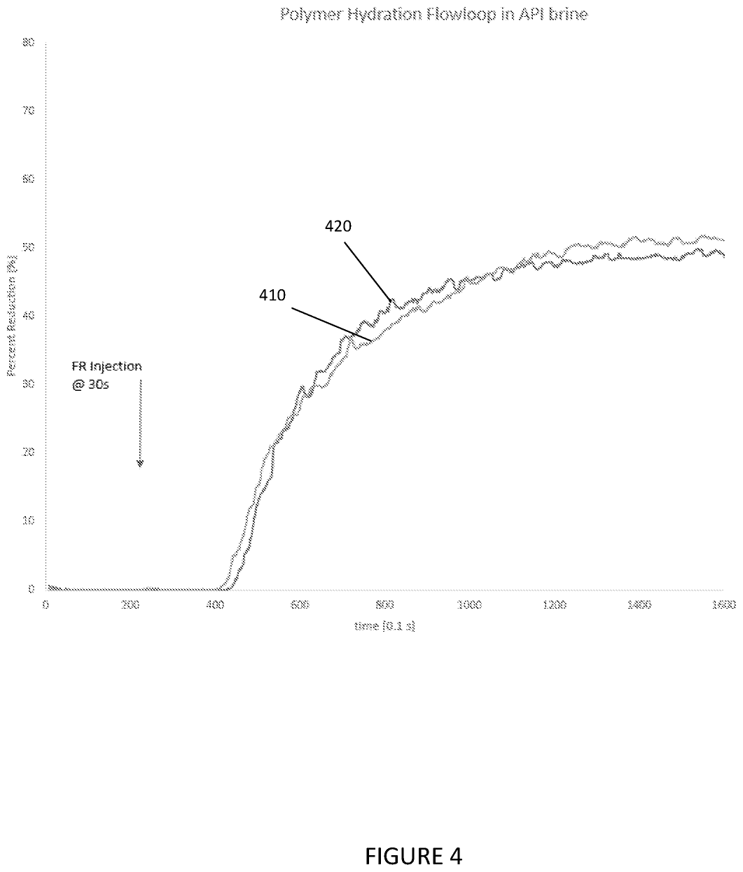

FIG. 4 depicts a graph 400 illustrating the friction reduction % (Y-axis) vs. time (X-axis) of first slurry 310 and second slurry 320, according to an embodiment. As depicted in FIG. 4, the addition of lubricant within the slurry slightly reduces the friction of the slurry over time. Additionally, the lubricant within the slurry may provide a better dispersion of the dry polymer by coating the surfaces of the parties, which reduces the coefficient of friction of the particles.

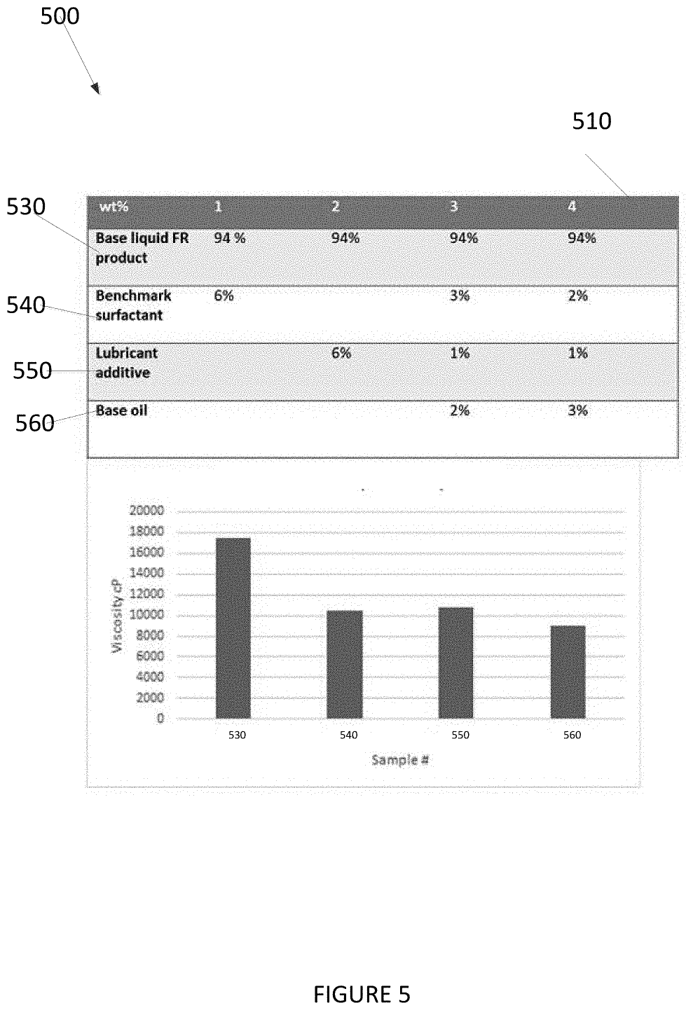

FIG. 5 depicts a table 510 and corresponding graph 520 illustrating viscosity reductions of four different slurries 530, 540, 550, 560, according to an embodiment.

As depicted in FIG. 5, a first slurry 530 that does not have any lubricant oil may have a higher viscosity than second slurry 540, third slurry 550, or fourth slurry 550. When the lubricant additive is added, the lubricant dramatically improves the pumpability especially at low temperatures during winter time. Specifically, even a 1% addition of lubricant substantially decreases the viscosity of the slurry.

In further embodiments, slurry including 20% lubricant additive, which is added to fresh water at 2 gpt may have a coefficient of friction of 0.078, which may reduce the coefficient of friction by up to 75%. By reducing the pipe on pipe friction coefficient, the lubricant within the slurry minimizes the erosion to pumping equipment. In embodiments, an amount of the lubricant additive may be less than the frication reducer within the slurry.

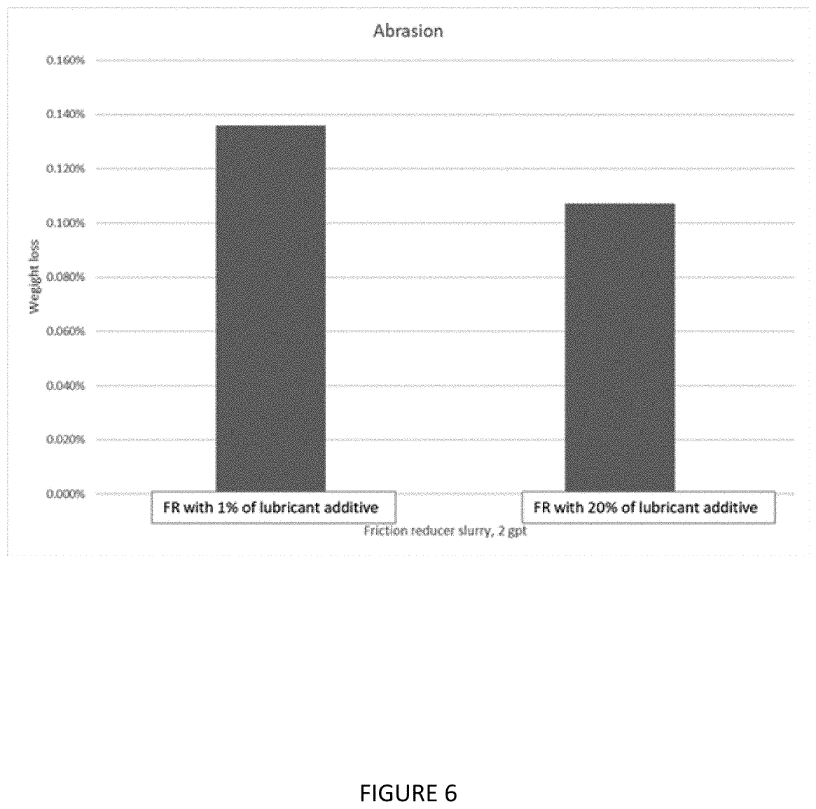

FIG. 6 depicts a graph 610 showing the results of weight loss (y-axis) for a first slurry 610 with 1% of lubricant additive and a second slurry 620 with 20% lubricant additive, according to an embodiment.

As depicted in FIG. 6, second slurry 620 may reduce abrasion on metallic surfaces at a greater rate than first slurry 610. Specifically, lubricant within the slurries may coat sand, proppant, or other suspended solids, and thus reduce the wearing on pressure pumping equipment effectively.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A slurry for oil and gas operations, the slurry comprised of:
hydrocarbons;
a viscosifier;
a dry friction reducer polymer; and
a lubricant, wherein the lubricant is a fatty acid amine including three to twenty carbon atoms.

2. The slurry of claim 1, wherein the lubricant is configured to reduce a temperature of the slurry when the slurry is being pumped.

3. The slurry of claim 2, wherein the lubricant is configured to reduce a viscosity of the slurry when the slurry is being pumped.

4. The slurry of claim 3, wherein the slurry includes one percent lubricant.

5. The slurry of claim 3, wherein the slurry includes twenty percent lubricant.

6. The slurry of claim 1, wherein the lubricant is configured to disperse the dry friction reducer polymer that is suspended in the slurry.

7. The slurry of claim 1, wherein the slurry includes more dry friction reducer polymer than lubricant.

8. The slurry of claim 1, wherein the slurry is configured to be used during a fracturing operation in a wellbore, wherein the slurry is created before being pumped downhole.

9. The slurry of claim 1, wherein the hydrocarbons are base oils.

10. The slurry of claim 9, wherein the viscosifier is organophilic clay or polymeric.

11. The slurry of claim 10, wherein the dry friction reducer polymer is an anionic or cationic polyacrylamide.

12. The slurry of claim 11, wherein the slurry is formed of twenty to fifty percent of the dry friction reducer polymer.
